(19) United States
(12) Patent Application Publication
(10) Pub. No.: US 2018/0085610 A1
(43) Pub. Date: Mar. 29, 2018

(54) MULTI-PURPOSE TOOL

(71) Applicant: Mahissara Aroonsawat, San Gabriel, CA (US)

(72) Inventor: Mahissara Aroonsawat, San Gabriel, CA (US)

(21) Appl. No.: 15/716,357

(22) Filed: Sep. 26, 2017

Related U.S. Application Data
(60) Provisional application No. 62/399,627, filed on Sep. 26, 2016.

(51) Int. Cl. A62B 3/00; B25B 13/50; B25F 1/00; B25B 13/48; B25B 15/02; G01B 3/04; G01B 3/56

(52) U.S. Cl. CPC A62B 3/005; B25B 13/5091; B25F 1/006; G01B 3/56; B25B 15/02; G01B 3/04; B25B 13/481

(57) ABSTRACT

A multi-purpose tool may comprise a head portion and a handle. The head portion has a wedge formed at a top end thereof and configured to pry open doorways, and a first notch located at an edge of the wedge is configured to pull a nail out. A snub nose axe formed at a first lateral edge of the head portion is configured to destroy a dry wall or chop a hinge of a door through a crack between the door and its frame. Also, a corner of the top end and the first lateral edge of the head portion is formed in a Chamfered corner, and a row of axe teeth formed on the Chamfered corner are configured to increase a contacted surface area for prying.

### CROSS-REFERENCE TO RELATED APPLICATIONS

This application claims priority under 35 U.S.C. § 119(e) to U.S. Provisional Patent Application Ser. No. 62/399,627, filed on Sep. 26, 2016, the entire contents of which are hereby incorporated by reference.

### FIELD OF THE INVENTION

The present invention relates to a multi-purpose tool, and more particularly to a multi-purpose tool for emergency situations.

### BACKGROUND OF THE INVENTION

An emergency situation such as fire and earthquake is always taken unpredictably, and according to statistics, death in such catastrophes frequently results from stuck in the building or debris. Thus, a multi-purpose tool can help a user escape and survive from disaster. In general, the multi-purpose tool may include a head portion and a handle, and tools such as wedge, wrenches, ruler, can opener, etc. can be formed on the head portion and the handle.

However, conventional multi-purpose tool may be disadvantageous because even though the conventional tool can be used for shutting off the gas or water valve or prying doorways during emergency situations, it is not powerful enough to destroy and open a distorted door caused by an earthquake or fire, nor cutting obstacles that may block escaping routes during emergency. Therefore, there remains a need for a new and improved design for a multi-purpose tool to overcome the problems presented above.

### SUMMARY OF THE INVENTION

In one aspect, a multi-purpose tool may include a head portion and a handle. The head portion has a wedge formed at a top end thereof and configured to pry open doorways, and a first notch located at nearly a center portion of the wedge is configured to pull a nail out. A snub nose axe formed at a first lateral edge of the head portion is configured to destroy a dry wall or chop a hinge of a door through a crack between the door and its frame. Also, a Chamfered corner is formed between the top end and the first lateral edge of the head portion, and a row of axe teeth formed on the Chamfered corner are configured to increase a contacted surface area for prying.

A lower end of the first lateral edge of the head portion has a vertical slot which is parallel with the handle, and a blade or a sharp edge is located inside the vertical slot to serve as a belt cutter such that a user can use one hand to hold the handle and use another hand to pull an object to accomplish cutting action through the belt cutter. A hammer protrudes from a second lateral edge of the head portion, and a lower end of the hammer has a first slot which is served as a hydrant hose remover. Moreover, a hexagonal-shaped opening connected to a top end of the hammer can be used as a screwdriver bit holder, and a body of a screwdriver bit is configured to laterally penetrate through and be held on the hexagonal-shaped opening. It is important to note that a corner edge on the Chamfered corner is parallel to an edge outside the first slot, so that when a user uses the tool in the present invention to pry open doorways or destroy dry walls, this parallel design enables the user to use his/her own weight to get the job done in a more efficient manner.

By winding a securing unit such as a rubber ring on the body of the screwdriver bit, the hammer and through the hydrant hose remover, the screwdriver bit is configured to be firmly secured on the screwdriver bit holder for use. A can opener can be formed at a top corner between the wedge and the second lateral edge of the head portion. A ruler is formed below the hydrant hose remover and extends to the handle. In addition, at least two rectangle apertures with different sizes respectively penetrating through a central portion of the head portion are configured to shut off gas or water valves with different sizes.

The multi-purpose tool further includes an elongated slot formed at an upper portion of the handle is served as a butterfly wrench which is configured to turn a butterfly screw or a butterfly fastener. Furthermore, a lower end of the ruler has an angle indicator which is configured to measure an angle of the boom relative to horizontal. Two round open holes respectively penetrating through two positions at a middle and lower portion of the handle are configured to cooperate with each other and wrap Paracord (a type of survival rope) therethrough. Two lateral edges of the handle has a plurality of indents which are configured to position the rubber rings or ropes disposed on the handle, and a capsule hole penetrating through a central portion of the handle between the two round open holes is configured to position the screwdriver bit thereon, and by cooperating with the rubber rings disposed on the handle, the screwdriver bit can be secured on the handle. Also, a wrench key chain hole which comprises at least two positions is formed at a lower portion of the handle to turn screws with different sizes, and an open-end wrench is formed at a lower end of the handle to shut off the gas or water valve in a narrow space.

In one embodiment, the two rectangle apertures are respectively sized to shut off ½ inch gas valve and ¾ inch gas valve.

### BRIEF DESCRIPTION OF THE DRAWINGS

FIG. 1 is a plan view of a multi-purpose tool in the present invention.

FIG. 2 is a schematic view of the multi-purpose tool illustrating a screwdriver bit is secured on a screwdriver bit holder of the present invention.

FIG. 3 is a schematic view of the multi-purpose tool illustrating two round open holes are used for a survival rope in the present invention.

FIG. 4 is a schematic view of the multi-purpose tool illustrating the screwdriver bit is secured on a capsule hole in the present invention through two rubber rings.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In order to further understand the goal, characteristics and effect of the present invention, a number of embodiments along with the drawings are illustrated as following:

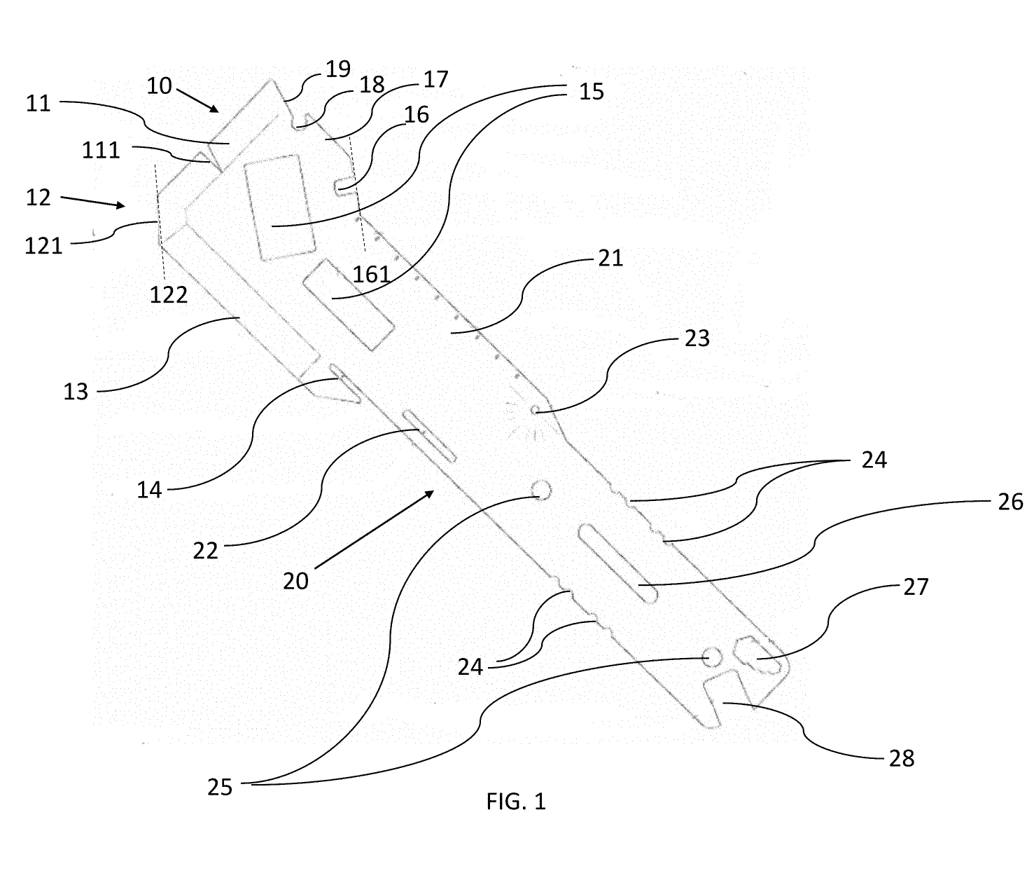

In one aspect, referring to FIGS. 1 to 4, a multi-purpose tool may include a head portion (10) and a handle (20). The head portion (10) has a wedge (11) formed at a top end thereof and configured to pry open doorways, and a first notch (111) located at nearly a center portion of the wedge is configured to pull a nail out. A snub nose axe (13) formed at a first lateral edge of the head portion (10) is configured to destroy a dry wall or chop a hinge of a door through a crack between the door and its frame. Also, a Chamfered corner (12) is formed between the top end and the first lateral edge of the head portion (10), and a row of axe teeth (121) formed on the Chamfered corner are configured to increase a contacted surface area for prying.

A lower end of the first lateral edge of the head portion (10) has a vertical slot (14) which is parallel with the handle (20), and a blade or a sharp edge is located inside the vertical slot to serve as a belt cutter such that a user can use one hand to hold the handle (20) and use another hand to pull an object to accomplish cutting action through the belt cutter. A hammer (17) protrudes from a second lateral edge of the head portion (10), and a lower end of the hammer (17) has a first slot (16) which is served as a hydrant hose remover. Moreover, a hexagonal-shaped opening (18) connected to a top end of the hammer (17) can be used as a screwdriver bit holder, and a body of a screwdriver bit is configured to laterally penetrate through and be held on the hexagonal-shaped opening (18). It is important to note that a corner edge (122) on the Chamfered corner is parallel to an edge (161) outside the first slot, so that when a user uses the tool in the present invention to pry open doorways or destroy dry walls, this parallel design enables the user to use his/her own weight to get the job done in a more efficient manner.

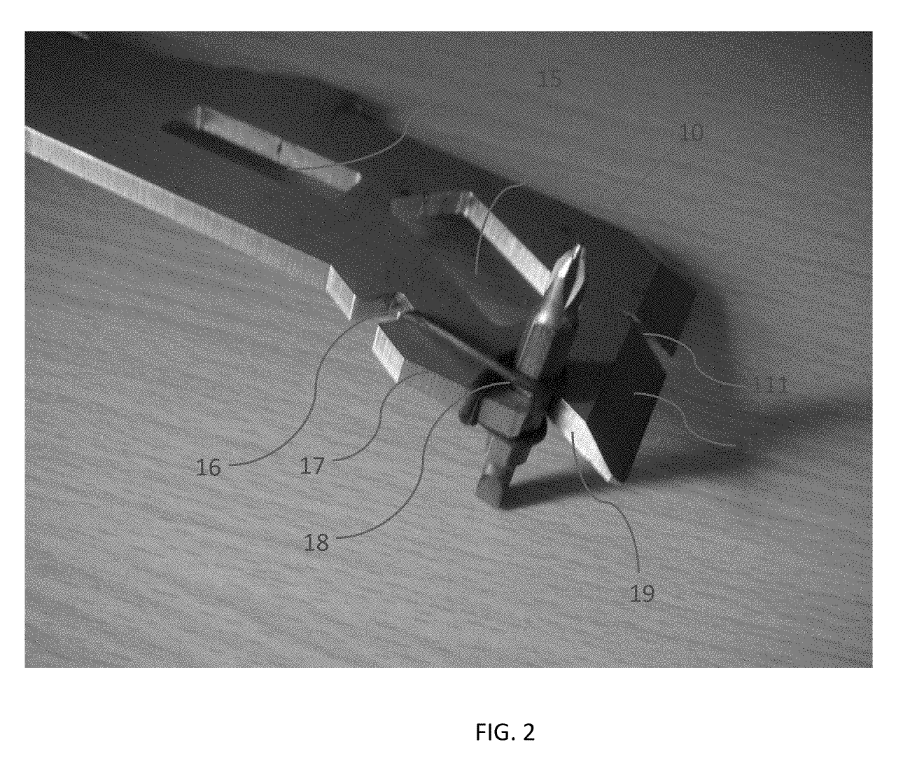

As shown in FIG. 2, by winding a securing unit such as a rubber ring on the body of the screwdriver bit, the hammer (17) and through the hydrant hose remover (16), the screwdriver bit is configured to be firmly secured on the screwdriver bit holder (18) for use. A can opener (19) can be formed at a top corner between the wedge (11) and the second lateral edge of the head portion (10). A ruler (21) is formed below the hydrant hose remover (16) and extends to the handle (20). In addition, at least two rectangle apertures (15) with different sizes respectively penetrating through a central portion of the head portion (10) are configured to shut off gas or water valves with different sizes.

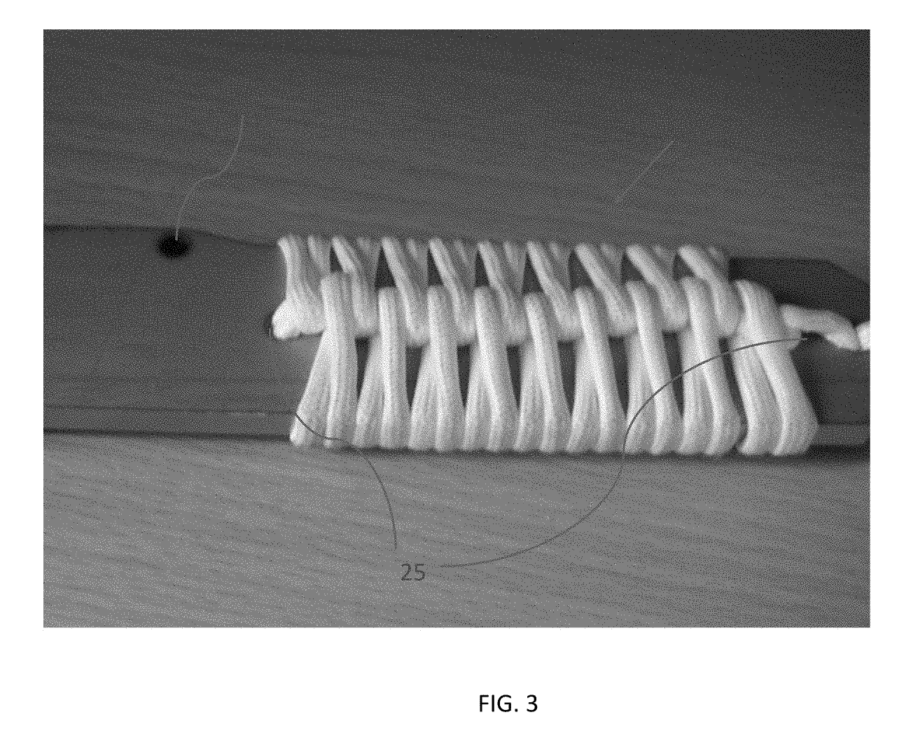

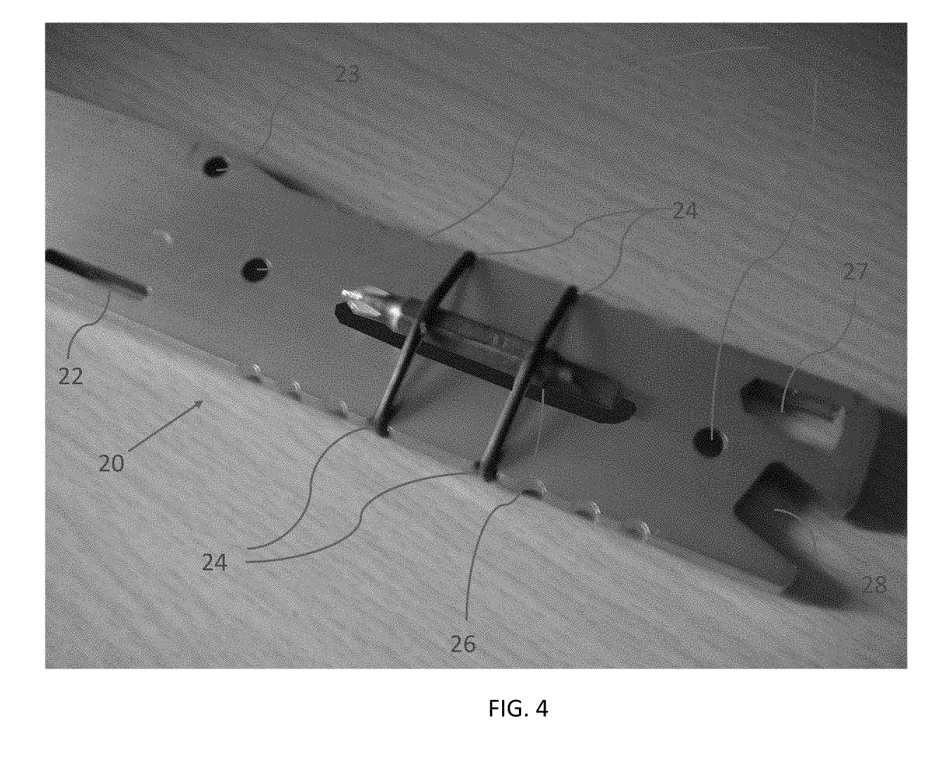

The multi-purpose tool further includes an elongated slot (22) formed at an upper portion of the handle (20) is served as a butterfly wrench which is configured to turn a butterfly screw or a butterfly fastener. Furthermore, a lower end of the ruler (21) has an angle indicator (23) which is configured to measure an angle of the boom relative to horizontal. Two round open holes (25) respectively penetrating through two positions at a middle and lower portion of the handle (20) are configured to cooperate with each other and wrap Paracord (a type of survival rope) therethrough (as shown in FIG. 3). Two lateral edges of the handle (20) has a plurality of indents (24) which are configured to position the rubber rings or ropes disposed on the handle (20), and a capsule hole (26) penetrating through a central portion of the handle (20) between the two round open holes (25) is configured to position the screwdriver bit thereon, and by cooperating with the rubber rings disposed on the handle (20), the screwdriver bit can be secured on the handle (20) as shown in FIG. 4. Also, a wrench key chain hole (27) which comprises at least two positions is formed at a lower portion of the handle (20) to turn screws with different sizes, and an open-end wrench (28) is formed at a lower end of the handle (20) to shut off the gas or water valve in a narrow space.

In one embodiment, the two rectangle apertures (15) are respectively sized to shut off ½ inch gas valve and ¾ inch gas valve.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A multi-purpose tool comprising a head portion and a handle;
wherein the head portion has a wedge formed at a top end thereof and configured to pry open doorways; a snub nose axe formed at a first lateral edge of the head portion to destroy a dry wall or chop a hinge of a door through a crack between the door and its frame; a Chamfered corner formed between the top end and the first lateral edge of the head portion; a hammer protruding from a second lateral edge of the head portion, and a lower end of the hammer having a first slot which is served as a hydrant hose remover; a hexagonal-shaped opening connected to a top end of the hammer used as a screwdriver bit holder, and a corner edge on the Chamfered corner being parallel to an outer edge outside the first slot to enable the user to use his/her own weight to pry open or destroy doorways;
wherein the handle has a ruler formed below the hydrant hose remover and extending therefrom; an elongated slot formed at an upper portion of the handle served as a butterfly wrench which is configured to turn a butterfly screw or a butterfly fastener; an angle indicator configured to measure an angle of the boom relative to horizontal; a capsule hole penetrating through a central portion of the handle between two round open holes configured to position the screwdriver bit thereon; and an open-end wrench formed at a lower end of the handle to shut off the gas or water valve in a narrow space.

2. The multi-purpose tool of claim 1, wherein a first notch located at nearly a center portion of the wedge is configured to pull a nail out.

3. The multi-purpose tool of claim 1, wherein a row of axe teeth formed on the Chamfered corner are configured to increase a contacted surface area for prying.

4. The multi-purpose tool of claim 1, wherein the head portion has at least two rectangle apertures with different sizes respectively penetrating through a central portion of the head portion to shut off gas or water valves with different sizes.
